(19) United States
(12) Patent Application Publication
(10) Pub. No.: US 2015/0360430 A1
(43) Pub. Date: Dec. 17, 2015

(54) DEVICE FOR PERFORATING AND COLLAPSING SPENT BEVERAGE CONTAINERS

(71) Applicant: Shawn D. Frazier, Dubuque, IA (US)

(72) Inventor: Shawn D. Frazier, Dubuque, IA (US)

(21) Appl. No.: 14/305,454

(22) Filed: Jun. 16, 2014

(51) Int. Cl. B30B 9/32; B30B 15/08; B26F 1/20; B02C 19/00; B30B 3/04; B30B 15/30

(52) U.S. Cl. CPC B30B 9/325; B30B 3/04; B30B 15/30; B26F 1/20; B02C 19/0093; B30B 15/08

(57) ABSTRACT

An apparatus for perforating and collapsing a plastic container includes a housing, a first rotating drum member configured to rotate in a first direction, a second rotating drum member configured to rotate in a second direction opposite to the first direction, a structural frame mounted to the second rotating drum member and configured to vary a size of a clearance between the first rotating drum member and the second rotating drum member and a stationary comb mounted perpendicular to a bottom of the first rotating drum member. A plurality of evenly-spaced spike strips are provided around a circumference of the first rotating drum member. Each spike strip extends along a length of the first rotating drum member. A plurality of evenly-spaced crimp bars are provided around a circumference of the second rotating drum member. Each crimp bar extends along a length of the second rotating drum member.

### FIELD

The present technology relates generally to the field of waste collection. More specifically, the present technology relates to a device and method for perforating and collapsing spent beverage containers such as plastic bottles for water, soft drinks, milk and juices.

### BACKGROUND

This section is intended to provide a background or context to the subject matter recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Public venues, such as theme parks or sports arenas face the challenge of recycling or otherwise disposing of a vast number of spent beverage containers per year. Certain public venues, such as state and federal parks or interstate rest areas face the added challenge of disposing of the spent beverage containers without a source of electricity to utilize in the disposal process.

A capped plastic beverage container can withstand 200 psi before the lid is compromised and the container expels the air inside. Therefore a capped spent beverage container must have holes punctured into its surface to allow trapped air to escape so the container can be properly collapsed to reduce its physical volume.

A need exists for improved technology, including technology that may address the above described problems. It is an object of the present invention to provide a device and method for perforating and collapsing spent, plastic beverage containers that is performed manually by a user without requiring electricity to operate the device. Allowing the user to perforate and collapse spent plastic beverage containers will benefit the recycling process of plastic beverage containers from start to finish, from the owner of the device to the large plastic recycling processor by increasing the amount of plastic bottles per cu. ft., ultimately decreasing the handling costs associated with disposing spent, plastic beverage containers. Such a device and method may reduce maintenance labor costs by increasing the volume of plastic recycling containers up to 64%.

### SUMMARY

In one aspect, an apparatus is provided for perforating and collapsing a plastic container that includes a housing, a first rotating drum member configured to rotate in a first direction, a second rotating drum member configured to rotate in a second direction opposite to the first direction, a structural frame mounted to the second rotating drum member and configured to vary a size of a clearance between the first rotating drum member and the second rotating drum member and a stationary comb mounted perpendicular to a bottom of the first rotating drum member. A plurality of evenly-spaced spike strips are provided around a circumference of the first rotating drum member. Each spike strip extends along a length of the first rotating drum member. A plurality of evenly-spaced crimp bars are provided around a circumference of the second rotating drum member. Each crimp bar extends along a length of the second rotating drum member. A drive wheel is manually rotated to actuate the first rotating drum member and the second rotating drum member such that the plastic bottle is perforated and collapsed between the plurality of spike strips and the plurality of crimp bars.

Additional features, advantages, and embodiments of the technology may be set forth from consideration of the following detailed description, drawings, and claims. Moreover, it is to be understood that both the foregoing summary of the present disclosure and the following detailed description are exemplary and intended to provide further explanation without further limiting the scope of the present disclosure claimed.

### BRIEF DESCRIPTION OF THE DRAWINGS

The disclosure will become more fully understood from the following detailed description, taken in conjunction with the accompanying figures, in which:

FIG. 1 is a perspective view of an embodiment of a perforating and collapsing mechanism.

FIG. 2 is a front view of the perforating and collapsing mechanism of FIG. 1 with a frame.

FIG. 3 is a perspective view of an embodiment of a perforating/tearing drum and a collapsing/crimping drum.

FIG. 4 is a perspective view of an embodiment of a housing for the perforating/tearing and collapsing/crimping mechanism of FIG. 3.

FIG. 5 is a perspective view of an embodiment of a housing with a manual drive wheel, a container deposit door and access panels.

FIG. 6 is a front view of an embodiment of the container deposit door of FIG. 5 with a spent beverage container deposited within.

FIG. 7 is a side view of an embodiment the container deposit door of FIG. 5 with a spent beverage container deposited within.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring, in general, to the figures, a device 100 for perforating/tearing and collapsing/crimping spent beverage containers and the associated parts of the device 100 are illustrated.

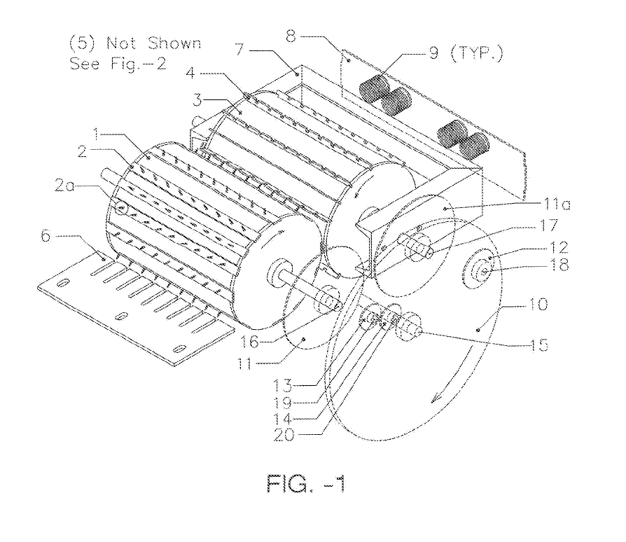

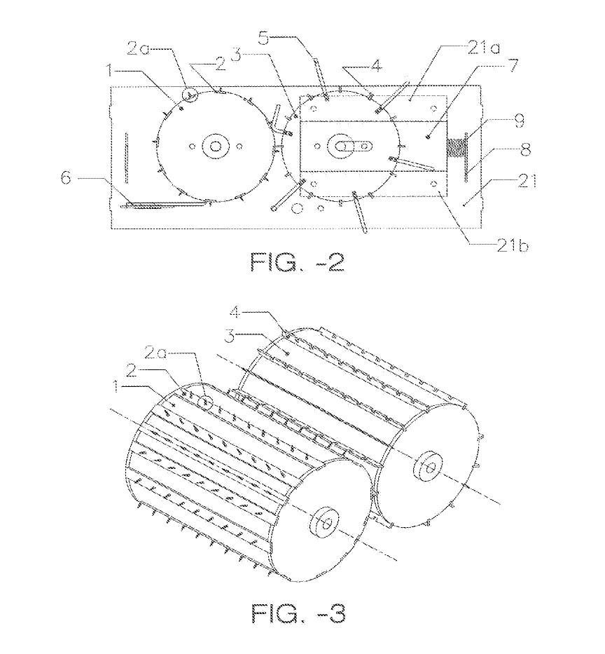

Referring now to FIGS. 1-3, the device 100 includes a rotating drum member 1 that rotates about an axis 16, a rotating drum member 3 that rotates about an axis 17, a perforating drum comb 6 that is mounted stationary and perpendicular to a bottom of the rotating drum member 1, and a variable diameter manual drive wheel 10 that rotates about an axis 15. The rotating drum member 1 and the rotating drum member 3 are provided substantially parallel to one another, thereby defining a clearance or space between the rotating drum member 1 and the rotating drum member 3. The clearance is configured to receive a spent, plastic beverage container to be perforated and collapsed. The rotating drum member 1 and the rotating drum member 3 rotate in opposite directions. For example, as illustrated, the rotating drum member 1 is provided on a left side of the device 100 and rotates in a clockwise direction, while the rotating drum member 3 is provided on a right side of the device 100 and rotates in a counter-clockwise direction. In other embodiments the rotating drum member 3 may be provided on the left side of the device 100 and configured to rotate in a clockwise direction, while the rotating drum member 1 may be provided on the right side of the device 100 and configured to rotate in a counter-clockwise direction. The parts of the device 100 may be mounted in a structural frame 21 (see FIG. 2).

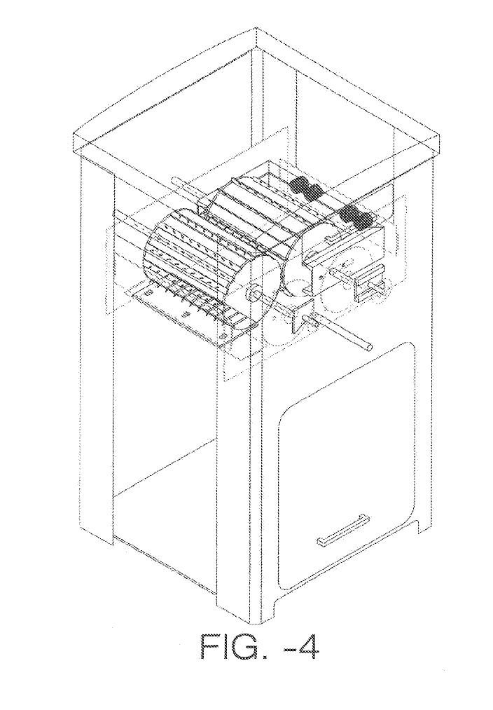

At least one perforating tearing spike strip 2 is attached to the rotating drum member 1 and extends along a length of the rotating drum member 1. As seen in FIGS. 1 and 3, the perforating tearing spike strip 2 may extend from a front of the rotating drum member 1 to a back of the rotating drum member 1 (i.e., the perforating tearing spike strip 2 extends along a full length of the rotating drum member 1). In another example (not illustrated), the perforating tearing spike strip 2 may extend along a partial length of the rotating drum member 1. In one embodiment, as illustrated in FIGS. 1 and 3, a plurality of evenly-spaced perforating tearing spike strips 2 are provided around a circumference of the rotating drum member 1. A distance between each of the perforating tearing spike strips 2 can be any suitable length, depending on the overall size of the device 100. For example, the tearing spike strips 2 may be spaced every 30 degrees on center on an 8⅝″ diameter rotating drum member 1 (i.e., a cylinder). More or less tearing spike strips 2 may be provided by changing the distance between the tearing spike strips 2 and/or the diameter of the rotating drum member 1.

Each perforating tearing spike strip 2 includes a plurality of pointed, ribbed spikes 2a that are configured to puncture and tear a surface of a spent, plastic beverage container in order to expel trapped gases. The pointed, ribbed spikes 2a are also configured to restrain the spent, plastic beverage container to assist in feeding the spent, plastic beverage container through the one step method for perforating and collapsing the spent, plastic beverage container. In one embodiment, the pointed ribbed spikes 2a are stainless steel sheet metal screws. The ribbed surfaces of the pointed ribbed spikes 2a allow the spikes 2a to tear the plastic surface of the bottle. In particular, the pointed, ribbed spikes 2a puncture the surface of the bottle and cause the bottle to deform, leaving a puncture (i.e., a hole) that prevents the bottle from re-expanding and retaining air. The tear to the plastic surface of the bottle gives the puncture strength, allowing the puncture to remain open. In contrast, a smooth spike (i.e., not ribbed spiked) may allow the puncture to re-close, allowing the bottle to re-expand, thereby resulting in minimal compaction. In particular, a smooth spike may not deform the surface of the bottle when it punctures the bottle, which may allow the bottle to re-expand and retain air.

In some embodiments, the tearing spike strips 2 may be individually removable and replaceable for repair or maintenance purposes. For example, if the ribbed spikes 2a on a single tearing spike strip 2 are damaged, the single tearing spike strip 2 can be removed and replaced without replacing the other tearing spike strips 2 or the entire rotating drum member 1.

At least one crimp bar 4 is attached to the rotating drum member 3 and extends along a length of the rotating drum member 3. The crimp bar 4 is configured to compress the spent, plastic beverage container to expel trapped gases and to deform the spent, plastic beverage container's shape, leaving the spent, plastic beverage container in a compressed flat state. As seen in FIGS. 1 and 3, the crimp bar 4 may extend from a front of the rotating drum member 3 to a back of the rotating drum member 3 (i.e., the crimp bar 4 extends along a full length of the rotating drum member 3). In another example (not illustrated), the crimp bar 4 may extend along a partial length of the rotating drum member 3. In one embodiment, as illustrated in FIGS. 1 and 3, a plurality of evenly-spaced crimp bars 4 are provided around a circumference of the rotating drum member 3. A distance between each of the crimp bars 4 can be any suitable length, depending on the overall size of the device 100. For example, the crimp bars 4 may be spaced every 30 degrees on center on an 8⅝″ diameter rotating drum member 3 (i.e., a cylinder). More or less crimp bars 4 may be provided by changing the distance between the crimp bars 4 and/or the diameter of the rotating drum member 3.

The crimp bar 4 includes a plurality of protrusions and grooves. In one embodiment, the protrusions and grooves are substantially rectangular-shaped. The protrusions or raised bars of the crimp bar 4 are configured to collapse and deform the spent beverage container into a permanent flat state, reducing the spent beverage container's physical pre-collapsed volume. The grooves are provided to allow the spikes 2a to pass the crimp bar 4 without contact, in the event that the rotating drum member 1 and the rotating drum member 3 are out of sync. For example, in some embodiments, the grooves are configured to consistently hold a ⅛″ minimum clearance between the rotating drum member 1 and the rotating drum member 3. The minimum clearance may vary depending on the size and requirements of the device 100. The grooves may also assist in deforming the surface of the bottle such that the bottle remains in a compacted state. Although the protrusions and grooves are substantially rectangular-shaped, one of ordinary skill in the art would appreciate that other shapes may be used, including, but not limited to triangular-shaped or square-shaped protrusions and grooves.

As seen in FIG. 2, the rotating drum member 3 further includes at least one container grabber 5 configured to collect loose, spent, plastic beverage containers and to feed the spent, plastic beverage containers to the clearance between the rotating drum member 1 and the rotating drum member 3. In one embodiment, as illustrated in FIG. 2, the rotating drum member 3 may include a plurality of container grabbers 5, evenly-spaced about a circumference of the rotating drum member 3. The container grabbers 5 are flexible members configured to repeatedly and reversibly deform upon entering the clearance between the rotating drum member 1 and the rotating drum member 3. For example, the container grabbers 5 may be made of surgical rubber hose, high density plastic filament line, or any other suitable, flexible material. The container grabbers 5 have a height greater than a height of the spikes 2a or the protrusions on the crimp bar 4. In one embodiment, the height of the container grabber 5 is at least the same length as a diameter of a standard 16.9 oz. plastic water bottle. The height of the container grabber 5 may be any suitable height, depending on the size of the other components of the device 100.

The rotating drum member 3 is mounted to a structural c-frame 7 that is configured to expand the distance between the rotating drum member 1 and the rotating drum member 3 in order to allow passage of foreign objects that are not collapsible. The c-frame 7 allows the device 100 to perforate and collapse multiple sizes of spent beverage containers. Without the ability to expand the clearance between the rotating drum member 1 and the rotating drum member 3, via the c-frame 7, the device 100 could not be manually operated because of the force required to pass the top portion of the spent beverage container between the rotating drum member 1 and the rotating drum member 3. The c-frame 7 is mounted between two rails of the structural frame 21: an upper rail 21a and a lower rail 21b. See FIG. 2. The c-frame 7 rides or sets on the lower rail 21b, while the upper rail 21a keeps the rotating drum member 3 from moving out of its forward, parallel position with the rotating drum member 1. The central axis of the rotating drum member 3 rides in a slot cut into the structural frame 21. The slot dimensions control the axial movement of the rotating drum member 3. For example, in one embodiment, the slot dimensions may limit the clearance between the rotating drum member 1 and the rotating drum member 3 to a minimum clearance of ⅛″ and a maximum clearance of 3″. In order to vary the size of the clearance between the rotating drum member 1 and the rotating drum member 3, the rotating drum member 3 and the c-frame 7 are configured to translate within the structural frame 21, between the upper rail 21a and the lower rail 21b.

The device 100 further includes a stabilizer plate 8 configured to provide a solid mounting surface for at least one coil spring 9. In one embodiment, as illustrated in FIG. 1, a plurality of coil springs 9 is provided. The coil springs 9 may be evenly-spaced along a length of the plate 8, or grouped in pairs along the length of the plate 8. By being evenly-spaced, the coil springs 9 are capable of providing even pressure on the c-frame 7, which keeps the c-frame 7 from binding between the upper rail 21a and the lower rail 21b. Thus, the entire surface of the rotating drum member 1 and the rotating drum member 3 may be utilized, and a container may be inserted into the clearance between the rotating drum member 1 and the rotating drum member 3 in any orientation and still undergo maximum perforation and compaction.

The coil springs 9 are configured to provide a positive, inward pressure to the c-frame 7, to allow the rotating drum member 3 to collapse and deform the perforated beverage containers. In particular, although the c-frame 7 is configured to expand the clearance between the rotating drum member 1 and the rotating drum member 3, the coil springs 9 provide the positive inward pressure that allows the rotating drum member 1 and the rotating drum member 3 to return to a home position (i.e., a predetermined distance apart). In particular, the coil springs 9 are configured to push and hold the rotating drum member 3 and the c-frame 7 forward in the slot in the structural frame 21, thereby maintaining a minimum predetermined distance between the rotating drum member 1 and the rotating drum member 3 across an entire surface of the rotating drum member 1 and the rotating drum member 3. For example, the minimum predetermined distance may be ⅛″. When an object enters the clearance between the rotating drum member 1 and the rotating drum member 3, the coil springs 9 are configured to contract, allowing the clearance (i.e., the distance) between the rotating drum member 1 and the rotating drum member 3 to expand and allow the object to pass. The coil springs 9 apply positive pressure to the c-frame 7, forcing the rotating drum member 3 towards the rotating drum member 1 during the entire process. The forward pressure provided by the coil springs 9 to the rotating drum member 3 assures maximum compaction and perforation to the container passing between the rotating drum member 1 and the rotating drum member 3. As discussed above, the distance between the rotating drum member 1 and the rotating drum member 3 is variable. Therefore, if the device 100 is in a remote area (e.g., a state park) and a user puts a foreign object such as a rock in the device 100, the distance between the rotating drum member 1 and the rotating drum member 3 will expand, allowing the rock to pass through the clearance and cause minimal damage to the spikes 2a and the crimp bars 4. The variable distance between the rotating drum member 1 and the rotating drum member 3 may also facilitate maintenance and improve the lifespan of the device 100. In addition, the variable distance between the rotating drum member 1 and the rotating drum member 3 may assist in decreasing the amount of force it takes to manually crush a bottle, by letting the thicker mouth of the bottle pass through the rotating drum member 1 and the rotating drum member 3 with less resistance.

As seen in FIGS. 1 and 2, the perforating drum comb 6 is mounted stationary, and perpendicular to a bottom of the rotating drum member 1 with minimal surface clearance. The perforating drum comb 6 is configured to remove impaled, plastic beverage containers or debris from the rotating drum member 1, as the rotating drum member 1 rotates. The perforating drum comb 6 removes debris that would otherwise clog the rotating drum member 1 and obstruct intake of the spent beverage container.

The actuating mechanism of the device 100 includes a plurality of sprockets. The variable diameter manual drive wheel 10 actuates a drive sprocket 13, rotating drum member 1, and rotating drum member 3. Variable diameter sprockets 11 and 11a rotate about an axis 16 and an axis 17, respectively. The variable diameter sprockets 11 and 11a are connected to the rotating drum members 1 and 3. A variable diameter idle sprocket 12 rotates about an axis 18. An adjustable variable diameter idle sprocket 13 rotates about an axis 19. The adjustable idle sprocket 13 keeps the drive train under tension when the rotating drum member 1 and the rotating drum member 3 are expanded apart so that the drive chain will not slip during operation. A variable diameter drive sprocket 14 rotates about an axis 20. The combination of sprockets allows a user to rotate a handle of the variable diameter manual drive wheel 10 to simultaneously rotate the rotating drum member 1 and the rotating drum member 3 at the same speed, to perforate and collapse spent beverage containers in a one step process. All of the drive and idle sprockets are designed to allow for minimum force to operate the device 100 manually (i.e., without an electric motor). One of ordinary skill in the art will appreciate that the diameters of any of the sprockets may be varied to change the speed of rotation of one or both of the rotating drum member 1 and the rotating drum member 3. In some embodiments, the rotating drum member 1 and the rotating drum member 3 may rotate at different speeds.

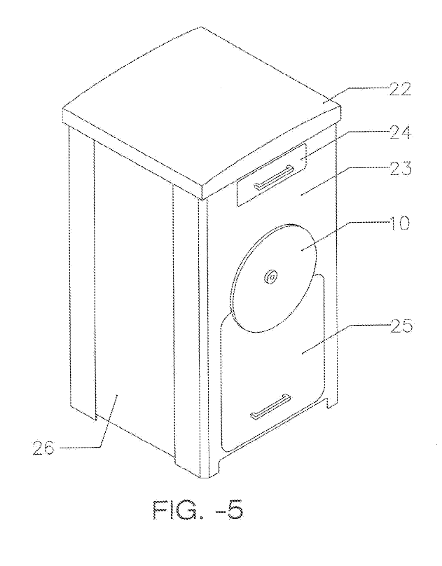

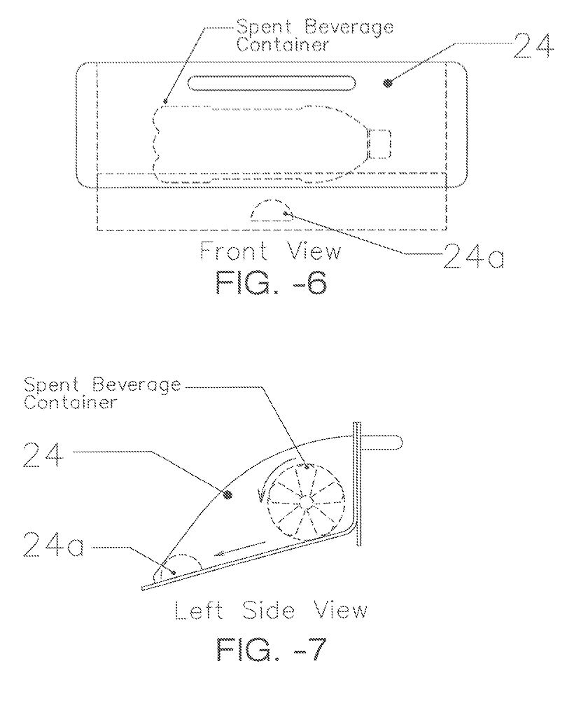

Referring now to FIGS. 4 and 5, the device 100 may be provided in a housing enclosure 200. The housing enclosure 200 includes a removable top 22 for maintenance access and a spent beverage container deposit door 24 configured to receive spent beverage containers deposited by users. The container deposit door 24 is appropriately sized such that a user may only insert objects that will fit between the rotating drum member 1 and the rotating drum member 3. In one embodiment, the container deposit door 24 comprises a first wall and a second wall connected to each other at an angle greater than 90 degrees such that when the container deposit door 24 is closed, the first wall is oriented in a substantially vertical position, while the second wall is oriented in a downwardly declining position. In some embodiments, the container deposit door 24 may also be an interlock or safety feature that prevents access to the rotating drum member 1 and the rotating drum member 3 when the container deposit door 24 is open. See FIGS. 6 and 7. For example, when the container deposit door 24 is open, the first wall is oriented in a substantially horizontal position and protrudes outwards from the housing enclosure 200, while the second wall is oriented in a an upwardly inclining position that blocks access to the rotating drum member 1 and the rotating drum member 3. In one embodiment, the operation of the container deposit door 24 is similar to that of the deposit door of a United States Postal Service mailbox. Therefore, a user or maintenance worker cannot stick his or her arm or hand in the container deposit door 24 and accidentally operate the device 100.

The container deposit door 24 may include a protrusion 24a (see FIGS. 6 and 7) on the interior surface of the container deposit door 24. In particular, the protrusion 24a is provided on the second wall of the container deposit door 24. When a spent beverage container is deposited within the container deposit door 24, the container rolls downward on the declined interior surface of the deposit door 24 via gravity and contacts the protrusion 24a. The container contacts the protrusion 24a at an approximately 90 degree angle. Upon contact with the container, the protrusion 24a is configured to rotate the container 180 degrees such that the container slides into the clearance between the rotating drum member 1 and the rotating drum member 3 in an orientation substantially parallel to the rotating drum member 1 and the rotating drum member 3. One of ordinary skill in the art will appreciate that even if the protrusion 24a is unable to rotate the container 180 degrees, the rotating drum member 1 and the rotating drum member 3 are capable of receiving the container in any orientation. The protrusion 24a may be made, for example, of plastic, steel, etc. and the dimensions of the protrusion 24a may vary. The protrusion 24a is preferably located on an interior surface of the container deposit door 24 at a position approximately in the center of the bottom edge of the container deposit door 24.

A handle of the manual drive wheel 10 is configured to protrude from the housing enclosure 200, to allow the user to initiate the perforating and collapsing process by rotating the handle, for example, in a counter-clockwise direction. In other embodiments, in place of a handle, a circumference of the manual drive wheel 10 may be recessed such that the user can turn the manual drive wheel 10 by placing his or her finger tips in the recess and turning the manual drive wheel 10.

The housing enclosure 200 further includes a container access door 25 to allow an employee to remove a collection container filled with the perforated and collapsed beverage containers that have passed through the device 100. The housing enclosure 200 may further include a removable side panel 26 configured to provide access to the device 100 to facilitate maintenance of the device 100. In some embodiments, the panel 26 may also serve a dual purpose of being an advertising panel.

A method of operating the device 100 will now be described. A user deposits a spent beverage container in the spent beverage container deposit door 24 of the housing enclosure 200. The user then rotates the handle of the variable diameter manual drive wheel 10, which simultaneously engages and rotates the rotating drum member 1 and the rotating drum member 3. The rotating drum member 1 and the rotating drum member 3 rotate in opposite directions such that the spent beverage container is introduced into the clearance between the rotating drum member 1 and the rotating drum member 3. The flexible container grabber 5 may assist in directing the spent beverage container into the clearance between the rotating drum member 1 and the rotating drum member 3.

The spent beverage container is punctured/torn and impaled on the pointed ribbed spikes 2a of the rotating drum member 1. At the same time, the protrusions of the crimp bar 4 of the rotating drum member 3 crush/crimp the spent beverage container by forcing the spent container into the face of the rotating drum member 1 under pressure, causing the spent container to collapse and deform into a permanent flat state, thereby reducing the spent beverage container's pre-collapsed volume. The stationary comb 6 contacts and dislodges the impaled spent beverage container or other trash that has accumulated on the spikes 2a of the rotating drum member 1. The perforated and collapsed spent beverage container then falls by gravity into a container (e.g., a recycling container) disposed below the device 100. An employee of the facility can remove the container through the container access door 25 of the enclosure 200 and the perforated and collapsed beverage containers can be sent to a recycling plant or other waste facility.

### Examples

### Example 1

A first experiment was conducted to determine the increased capacity of a collection container disposed below the device 100 with respect to the capacity of a collection container configured to collect spent beverage containers that were not first perforated and collapsed by the device 100. The collection container had a length of 14.5 inches, a width of 13 inches and a height of 16 inches. The total volume of the collection container was 3016 inches³. A random assortment of spent beverage containers having different volumes were dropped from a consistent height of 30 inches in a non-compacted state (i.e., a state in which the spent beverage container was dropped into the collection container without pre-processing by the device 100), and then in a compacted state (i.e., a state after the spent beverage container was perforated and collapsed by the device 100). The collection container was capable of holding 50 uncollapsed bottles, while the same collection container was capable of holding 80 collapsed bottles. The same 30 bottles were used when evaluating the collection container's capacity for uncollapsed and collapsed bottles, and an additional 30 bottles of the same size, shape, and material were collapsed to fill the container completely when evaluating the container's capacity for collapsed bottles. The container was deemed at capacity when no more bottles could be dropped into the container without the bottles already in the container falling out. In other words, pre-processing by the device 100 increased the bottle capacity of the container by 60%.

### Example 2

In a second experiment, a different set of bottles was used from the first experiment. The volume of each bottle was measured before and after compaction with the device 100. Volumes were measured using a dry sand method including a one-gallon pitcher, a four-cup measuring cup, and a 50 lb bag of dry sand. In particular, a half-cup of sand was placed in the pitcher and spread evenly across the bottom of the one gallon pitcher. A non-compacted bottle (i.e., a spent beverage container that did not undergo pre-processing by the device 100) was then placed upright in the pitcher, and dry sand was added to the pitcher with the four-cup measuring cup until the pitcher was filled to a predetermined measured mark on the pitcher, at which sand covered the top of the bottle completely. The dry sand method was repeated for the same bottle after the bottle was compacted (i.e., after the spent beverage container was perforated and collapsed by the device 100). Several different brands and sizes of bottles were tested, and the results were averaged.

After averaging five trials, the inventor found that a non-compacted 20 oz. water bottle required an average of 12.5 cups of sand to cover the bottle to the mark, while a compacted 20 oz. water bottle required an average of 13.5 cups of sand to cover the bottle to the mark. In other words, the decrease in volume of the compacted water bottle was 1 cup (i.e., 8 oz), which is a 40% reduction in volume. For 16.9 oz. water bottles, pre-processing in the device 100 reduced the volume of the bottles by an average of 64%. For 20 oz. soda bottles, pre-processing in the device 100 reduced the volume of the bottles by an average of 42.5%. The average total reduction of volume for miscellaneous plastic bottles pre-processed in the device 100 was 48.33%. The differences in compaction percent for 20 oz. water bottles and 20 oz. soda bottles may be attributed to the different thicknesses of the bottles.

### Alternative Embodiments

As illustrated in FIGS. 1-4, the rotating drum member 1 and the rotating drum member 3 are substantially the same size and have substantially the same diameter. In other embodiments, a diameter of one of the rotating drum member 1 and the rotating drum member 3 may be larger than the other of the rotating drum member 1 and the rotating drum member 3. As mentioned above, in other embodiments, the rotational speed of the rotating drum member 1 and the rotating drum member 3 may be varied such that one of the rotating drum member 1 and the rotating drum member 3 rotates faster relative to the other.

The device 100 and method of operating the device 100 described in the embodiments above perforates and collapses used plastic beverage containers to decrease the physical area consumed by non-collapsed plastic bottles. This reduces the overall cost of handling the spent plastic beverage containers by increasing the volume of spent, plastic beverage containers a recycling container or garbage container can hold. The device 100 can be installed in any location because it requires no electricity to operate. For example, the device 100 can be installed at military bases, parks, interstate rest areas, cruise ships, naval ships, theme parks, sports arenas, private and public schools and colleges. Moreover, the device 100 is considered a GREEN product because it does not require the use of electricity or fossil fuels to operate. Therefore, the device 100 also assists in the reduction of the carbon footprint of a facility that utilizes the device 100, which could result in the facility owner being eligible for carbon credits.

The construction and arrangements of the device for perforating and collapsing spent beverage containers, as shown in the various exemplary embodiments, are illustrative only. As used herein, the terms “bottle,” “container” and “spent beverage container” may be used interchangeably. Although only a few embodiments have been described in detail in this disclosure, many modifications are possible (e.g., variations in sizes, dimensions, structures, shapes and proportions of the various elements, values of parameters, mounting arrangements, use of materials, colors, orientations, image processing and segmentation algorithms, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

What is claimed:

1. An apparatus for perforating and collapsing a plastic container comprises:
a housing;
a first rotating drum member configured to rotate in a first direction;
a plurality of evenly-spaced spike strips provided around a circumference of the first rotating drum member, each spike strip extending along a length of the first rotating drum member;
a second rotating drum member configured to rotate in a second direction opposite to the first direction;
a plurality of evenly-spaced crimp bars provided around a circumference of the second rotating drum member, each crimp bar extending along a length of the second rotating drum member;
a structural frame mounted to the second rotating drum member and configured to vary a size of a clearance between the first rotating drum member and the second rotating drum member, the clearance configured to receive the plastic container; and
a stationary comb mounted perpendicular to a bottom of the first rotating drum member.

2. The apparatus of claim 1, wherein the first rotating drum member is oriented parallel to the second rotating drum member with respect to a width of the apparatus.

3. The apparatus of claim 1, wherein each spike strip comprises a plurality of ribbed spikes configured to puncture and tear a surface of the plastic container in order to expel trapped gases.

4. The apparatus of claim 3, wherein each crimp bar comprises a plurality of protrusions and groove, the protrusions configured to collapse and deform the plastic container and the grooves configured to allow the ribbed spikes to pass the crimp bar without contacting the second rotating drum member.

5. The apparatus of claim 1, further comprising a stabilizer plate including a plurality of evenly-spaced coil springs mounted a length of the stabilizer plate, the stabilizer plate configured to exert a positive, inward pressure on the structural frame to maintain a forward position of the second rotating member for maximum compaction and perforation of the plastic container passing through the clearance between the first rotating drum member and the second rotating drum member.

6. The apparatus of claim 1, wherein the structural frame comprises an upper rail, a lower rail, and a c-frame slidably engaged with the upper rail and the lower rail, wherein the second rotating drum is configured to axially translate within a slot of the structural frame such that a clearance between the first rotating drum member and the second rotating drum member is variable.

7. The apparatus of claim 3, wherein the stationary comb is configured to abut and remove a plastic container impaled on the ribbed spikes as the first rotating drum member rotates.

8. The apparatus of claim 1, further comprising a manual drive wheel configured to actuate the first rotating drum member and the second rotating drum member.

9. The apparatus of claim 8, wherein an exterior of the housing includes a handle configured to rotate the manual drive wheel.

10. The apparatus of claim 1, wherein the housing includes a container deposit door configured to receive the plastic container, the container deposit door including a wall having a downwardly sloped surface such that the plastic bottle can roll down the wall by gravity and enter the clearance between the first rotating drum member and the second rotating drum member.

11. The apparatus of claim 10, wherein the downwardly sloped surface of the container deposit door includes a protrusion configured to contact and rotate the plastic container 180 degrees such that the plastic container falls into the clearance between the first rotating drum member and the second rotating drum member in an orientation substantially parallel to the first rotating drum member and the second rotating drum member.

12. The apparatus of claim 10, wherein the container deposit door includes an interlock that prevents access to the first rotating drum member and the second rotating drum member when the container deposit door is open.

13. The apparatus of claim 8, further comprising a plurality of sprockets configured to rotate the first rotating drum member and the second rotating drum member at a same speed when the manual drive wheel is operated.

14. The apparatus of claim 1, further comprising a collection container configured to receive perforated and collapsed plastic containers.

15. The apparatus of claim 14, further comprising a container access door configured to facilitate removal of the collection container to empty the perforated and collapsed plastic containers.

16. The apparatus of claim 1, wherein the apparatus is configured to perforate and collapse the plastic container without a source of electricity.

17. The apparatus of claim 1, further comprising at least one flexible grabber configured to facilitate feeding plastic beverage containers into the clearance between the first rotating drum member and the second rotating drum member.

18. The apparatus of claim 17, wherein a height of the at least one flexible grabber is greater than a height of the spike strips and a height of the crimp bars.

19. A method for perforating and collapsing a plastic container, the method comprising:
depositing the plastic container in a container deposit door in the housing of the apparatus of claim 1; and
manually rotating a drive wheel to actuate the first rotating drum member and the second rotating drum member such that the plastic bottle is perforated and collapsed between the plurality of spike strips and the plurality of crimp bars.
